(19) United States
(12) Patent Application Publication
(10) Pub. No.: US 2010/0177718 A1
(43) Pub. Date: Jul. 15, 2010

(54) USE OF NETWORK CAPACITY

(75) Inventors: David Harle, Glasgow (GB); Christos Tachtatzis, Glasgow (GB); Gordon Morison, Glasgow (GB)

Correspondence Address: PEPPER HAMILTON LLP, ONE MELLON CENTER, 50TH FLOOR, 500 GRANT STREET, PITTSBURGH, PA, 15219, US

(73) Assignee: ITI SCOTLAND LIMITED, Glasgow (GB)

(21) Appl. No.: 12/600,589

(22) PCT Filed: May 9, 2008
(86) PCT No.: PCT/GB08/01621

§ 371 Date: Mar. 9, 2010

(30) Foreign Application Priority Data
May 18, 2007 (GB) 0709653.0

(51) Int. Cl. H04W 72/00; H04B 7/00

(52) U.S. Cl. 370/329; 455/500; 370/348

(57) ABSTRACT

There is provided a method of improving the use of the capacity of an ultra wideband network, the network comprising a plurality of channels the network further comprising a plurality of devices, each device forming a respective beacon group on a first one of the channels, each beacon group including at least one other device in the plurality of devices; the method comprising transmitting data from a first device in a beacon group using a channel other than the first channel whilst a second device in the beacon group transmits data using the first channel.

### TECHNICAL FIELD OF THE INVENTION

The invention relates to method and apparatus for improving the usage of the available capacity in communication networks, and in particular relates to improving the usage of the available capacity in ultra wideband networks.

### BACKGROUND TO THE INVENTION

Ultra-wideband is a radio technology that transmits digital data across a very wide frequency range, 3.1 to 10.6 GHz. By spreading the RF energy across a large bandwidth the transmitted signal is virtually undetectable by traditional frequency selective RF technologies. However, the low transmission power limits the communication distances to typically less than 10 to 15 meters.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 10-15 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312.5 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

A sequence of three frequencies on which each data symbol is sent represents a Time Frequency Code (TFC) channel. A first TFC channel can follow the sequence 1, 2, 3, 1, 2, 3 where 1 is the first sub-band, 2 is the second sub-band and 3 is the third sub-band. Second and third TFC channels can follow the sequences 1, 3, 2, 1, 3, 2 and 1, 1, 2, 2, 3, 3 respectively. In accordance with the ECMA-368 specification, seven TFC channels are defined for each of the first four band groups, with two TFC channels being defined for the fifth band group. The sequences for each of the TFC channels in the five band groups are shown in FIGS. 2(a)-(e).

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

In wireless networks such as UWB networks one or more devices periodically transmit a Beacon frame during a Beacon Period. The main purpose of the Beacon frame is to provide for a timing structure on the medium, i.e. the division of time into so-called superframes, and to allow the devices of the network to synchronize with their neighbouring devices.

The basic timing structure of a UWB system is a superframe as shown in FIG. 3. A superframe according to the European Computer Manufacturers Association standard (ECMA), ECMA-368 2^{nd} Edition, consists of 256 medium access slots (MAS), where each MAS has a defined duration e.g. 256 μs. Each superframe starts with a Beacon Period, which lasts one or more contiguous MAS's, during which devices can transmit their Beacon frames. The start of the first MAS in the Beacon Period is known as the Beacon Period Start Time (BPST). A Beacon group for a particular device is defined as the group of devices that have a shared Beacon Period Start Time (±1 μs) with the particular device, and which are in transmission range of the particular device.

In ECMA-368, data transmissions from communicating devices are carried in an explicit group of Medium Access Slots (MAS) over a single assigned time frequency code (TFC) channel. The mapping between devices and the MAS to be used (i.e. the indications of which device pairs will be communicating and in which Medium Access Slot(s)) is communicated by each device in the Beacon Period at the start of each superframe. Devices may also exchange data in unreserved MASs if the MASs are not Hard DRP reserved, or if Hard DRP or private reserved MASs are relinquished.

According to the current ECMA-368 standard, individual devices join an appropriate TFC channel and transmit/receive accordingly on this single channel until instructed otherwise. A change in the TFC channel used by a device or devices is managed by a higher layer, and requires the completion of the current superframe.

As a result of this limited ability to switch TFC channels, it is possible that some of the available TFC channels will not be active or associated with device pairs.

Thus, a significant part of the capacity of the UWB system could be left unused during a particular superframe.

Two schemes have been proposed for IEEE 802.11 that allow dynamic channel switching to overcome the above disadvantages.

The first of these is called Common Control Channel (described in CCC MMAC protocol by Mathilde Benveniste, IEEE P802.11, doc. IEEE 802.11-05/0666r3, 12th Sep. 2005), which requires a device to make a channel reservation and to broadcast this on a common control channel so that other devices are informed when particular slots will be reserved. However, implementing this protocol means that each device must have a second radio interface to constantly monitor the common control channel.

The second scheme is described in “Multi-Channel MAC for Ad Hoc Networks: Handling Multi-channel Hidden Terminals Using A Single Transceiver” by Jungmin So and Nitin Vaidya, Proceedings of MobiHoc'04, May 24-26 2004, Japan. In this scheme, synchronisation is required between devices (perhaps using the 802.11 Timing Synchronisation Function (TSF)), but synchronisation may fail for multi-hop connections. A channel is reserved during an Ad-Hoc Traffic Indication Map (ATIM) window, with the size of the window being dynamically changeable. During the ATIM window, devices only agree on a channel to be used. A device then uses the channel for the duration of a superframe (which is much greater than the duration of a MAS). One consequence of this scheme is that it raises load-balancing issues, and hence the throughput of the network may not actually be improved.

Therefore, there is a need for a method and apparatus that allows the use of the available capacity in the communication network to be improved, and which overcomes the disadvantages of the schemes set out above.

### SUMMARY OF THE INVENTION

According to a first aspect of the invention, there is provided a method of improving the use of the capacity of an ultra wideband network, the network comprising a plurality of channels, the network further comprising a plurality of devices, each device forming a respective beacon group on a first one of the channels, each beacon group including at least one other device in the plurality of devices; the method comprising transmitting data from a first device in a beacon group using a channel other than the first channel whilst a second device in the beacon group transmits data using the first channel.

According to a second aspect of the invention, there is provided a device for use in an ultra wideband network, the network comprising a plurality of channels, the device being adapted to form a beacon group with at least one other device on a first one of the channels, the device being further adapted to transmit data to a second device using a channel other than the first channel when the at least one other device in the beacon group is transmitting data using the first channel.

According to a third aspect of the invention, there is provided an ultra wideband network comprising a plurality of devices, with at least one device being as described above.

### BRIEF DESCRIPTION OF THE DRAWINGS

The invention will now be described in detail, by way of example only, with reference to the following drawings, in which:

FIG. 1 shows the arrangement of frequency bands in a Multi-Band Orthogonal Frequency Division Multiplexing (MB-OFDM) system for ultra-wideband communication;

FIGS. 2(a)-(e) show the sequence definitions of the TFC channels in each of the five band groups;

FIG. 3 shows the basic timing structure of a superframe in a UWB system;

FIG. 4 shows a timing structure for seven TFC channels over two consecutive superframes;

FIG. 5 shows an exemplary group of devices forming a network;

FIG. 6 is a diagram showing the transmission of data between the devices in the network of FIG. 5 in accordance with the prior art;

FIG. 7 is a diagram showing the transmission of data between the devices in the network of FIG. 5 in accordance with an embodiment of the invention;

FIG. 8 is a flow chart illustrating a method of initiating a device in accordance with the invention;

FIGS. 9(a) and (b) show an exemplary scheme for transmission of data between four devices in a network in accordance with the invention;

FIGS. 10(a) and (b) show an exemplary scheme for transmission of data between six devices in a network in accordance with the invention;

FIG. 11 shows the format of a Channel Control octet in accordance with an embodiment of the invention;

FIG. 12 shows the format of an availability Information Element in accordance with an embodiment of the invention;

FIG. 13 shows the format of an alternative availability Information Element in accordance with an embodiment of the invention;

FIG. 14 shows the format of a further alternative availability Information Element in accordance with an embodiment of the invention;

FIG. 15 shows the format of an Information Element in accordance with an embodiment of the invention; and

FIG. 16 shows the format of a DRP allocation field in accordance with an embodiment of the invention.

### DETAILED DESCRIPTION OF THE PREFERRED EMBODIMENTS

The invention will now be described with reference to an Ultra Wideband communications network, although it will be appreciated that the invention is applicable to other types of communication networks.

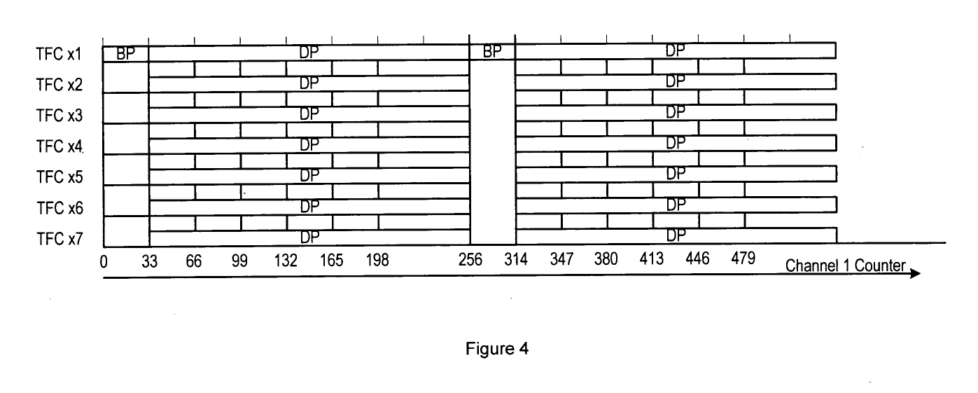

FIG. 4 shows the structure of seven TFC channels over two consecutive superframes, measured by the number of Medium Access Slots within a superframe. A Beacon Period for the first superframe is transmitted on TFCx₁ during, at most, the first 33 Medium Access Slots (it will be appreciated that the length of the Beacon Period is variable), and a Data Period (DP) is provided over the following 223 or more Medium Access Slots.

With reference FIG. 4, consider the situation where two devices have established data flows therebetween in accordance with the standard ECMA-368 specification. These devices are using the first channel, TFCx₁ to carry their data. The content of the Beacon Period (BP) at the start of the superframe indicates which slots (MAS) within the data period (DP) will hold transmitted data. If it is assumed that no other devices within the vicinity of the two devices are utilising any of the remaining six channels (TFCx₂-TFCx₇), then it is clear that the Data Period (DP) associated with each of these channels is not being used.

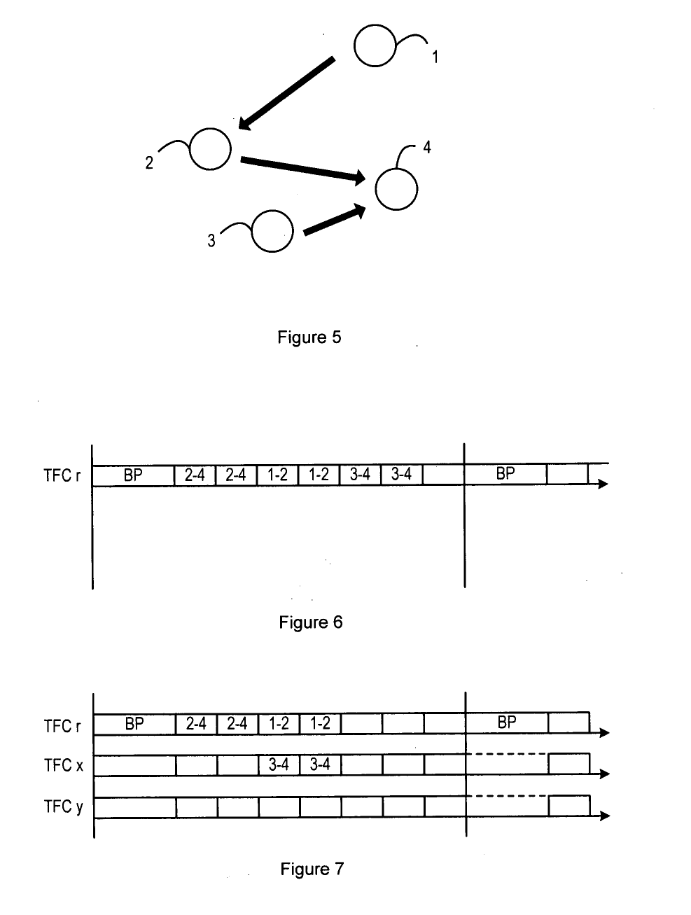

A similar situation exists for a plurality of devices in a network. An exemplary network is shown in FIG. 5, which comprises four devices, a first device 1, a second device 2, a third device 3 and a fourth device 4. The arrows between the devices indicate the direction that data is to be transmitted between various pairs of devices in the network. In the following, it is assumed that all the devices are within transmission range of each other, and they have a shared Beacon Period Start Time (±1 μs). Therefore the Beacon group for each device comprises each of the other three devices.

In the following, it should be noted that, for ease of illustration, each Data Period has been divided into seven ‘sets’ of MAS of equal size, with each data flow or demand (i.e. a certain number of symbols) requiring two of these slot sets to be transmitted.

FIG. 6 shows how these three data flows would be handled in a conventional ECMA-368 standard system. During the Beacon Period, each of the four devices 1, 2, 3 and 4 transmits details of, or resource reservation requests for, the data they need to transmit in the next Data Period to the other devices, and the usage of the seven ‘slots’ in the Data Period is determined accordingly.

Thus, in a conventional system, the second device 2 will transmit its data to the fourth device 4 in the first two slots, the first device 1 will transmit its data to the second device 2 in the third and fourth slots, and the third device 3 will transmit its data to the fourth device 4 in the fifth and sixth slots of the Data Period. Thus, the three separate data transmissions are carried out sequentially, since only one TFC channel can be used.

Again, if it is assumed that there are no other devices within the vicinity of the four devices and no other devices are utilising any of the remaining six channels (TFCx₂-TFCx₇), then it is clear that the Data Period (DP) associated with each of these channels is not being used.

In accordance with the invention, a scheme is proposed, provisionally entitled Virtual Multi-Channel Operation (VMCO), in which these empty channels and their Data Periods can be used to carry data (additional or otherwise) between devices currently associated with a first utilised channel.

As these otherwise empty channels are used to carry data, then the total available capacity in bits per second and number of available Data Period slots per superframe increases, giving a reduction in delay and an improvement in throughput. One advantage of this is an improvement in the efficiency with which peaks in traffic flows are handled, as well as an increase in the number of active node pairs that can be supported.

FIG. 7 shows how the three data flows in the network of FIG. 5 can be handled in the VMCO scheme in accordance with the invention. During the Beacon Period on one of the TFC channels, TFCᵣ, in FIG. 7, each of the four devices 1, 2, 3 and 4 transmits details of the data they need to transmit in the next Data Period to the other devices, and reserves slots for those transmissions in the superframe, as is conventional. However, it is determined whether the Data Periods of other TFC channels (labelled “TFCₓ” and “TFC_{y}” in FIG. 7) will be unused. If they are unused, a transmission scheme is determined for the devices in order to make the most appropriate use of the channels. Thus, the devices can reserve slots on the other channels (known hereafter as “virtual” channels) for the transmission of some or all of their data in the superframe. The information relating to the third device 3 and fourth device 4 as to when and where to switch channels is preferably included within an Information Element transmitted in the Beacon Period of TFCr, as will be described later in the application.

Thus, as shown in FIG. 7, the second device 2 will transmit its data to the fourth device 4 in the first two slots of the Data Period in TFCᵣ and the first device 1 will transmit its data to the second device 2 in the third and fourth slots of the Data Period in TFCᵣ, as with the conventional system. However, as the third device 3 and fourth device 4 are independent of the transmission taking place in the third and fourth slots on the TFCᵣ, the third device 3 and fourth device 4 can use an otherwise empty channel (a “virtual” channel), in this case, TFCₓ. Thus, the third device 3 will transmit its data to the fourth device 4 in the third and fourth slots of the Data Period of TFCₓ. Therefore, two of the three separate data transmissions are carried out contemporaneously, since multiple TFCs can be used, with the result that the three transmissions are completed in a shorter time than in the conventional system illustrated in FIG. 6.

After the third device 3 and fourth device 4 have transmitted their data, the devices 3, 4 switch back to the common channel (TFCᵣ) for subsequent unreserved communications and/or for the next Beacon Period.

Essentially, the invention allows device pairs that would be inactive, but awaiting a transmission slot, to switch channels within a superframe and to transmit their data in a slot on another channel, which would otherwise be unused. It should be noted that it is possible for devices to switch channel each time slot (MAS) within a superframe.

The information relating to when and where individual devices will switch to is preferably contained in an Information Element (IE) that is transmitted during the Beacon Period on a channel that is common to the devices. In other words, it is devices in a particular Beacon group that are able to implement the VMCO scheme between them. The absence or lack of a signal in the Beacon Period on other channels can indicate that the Data Period in the current superframe on those channels is empty. Thus, using this scheme, each device is associated with a common TFC (TFCᵣ in FIG. 7), but is able to receive or transmit data over other otherwise empty TFCs (TFCₓ in FIG. 7) in accordance with the information provided in the Beacon Period.

In one embodiment, each device uses Information Elements as resource reservation requests for multiple channels in the network.

The existing physical layer (PHY) specifications for ultra wideband communication systems indicate that, in terms of timing and synchronisation/alignment issues, ECMA-368 standard devices are capable of switching channels and aligning/synchronising sufficiently fast to allow the VMCO scheme to be implemented without substantial changes to the device hardware. All devices using the VMCO scheme are synchronised and aligned by the Beacon Period of the common channel, and thus share the same common representation of time. It is possible to consider the Data Periods of the other channels as virtual Data Periods of the channel that the Beacon group uses, or as a Data Period organised in both temporal and frequency dimensions.

VMCO devices can detect other VMCO capable devices in a variety of ways. One way to achieve this is for devices to use the MAC Capabilities IE provided by the ECMA-368 standard: one of the available bits (as shown in FIG. 81 of the ECMA-368 specification) in the MAC capability bitmap can be used to flag VMCO capabilities.

An alternative way could be to use an Application Specific IE. Application Specific IEs can be used by vendors to provide application specific functionality and their format is provided by the vendors themselves. Hence a vendor can use such an IE to indicate VMCO capabilities.

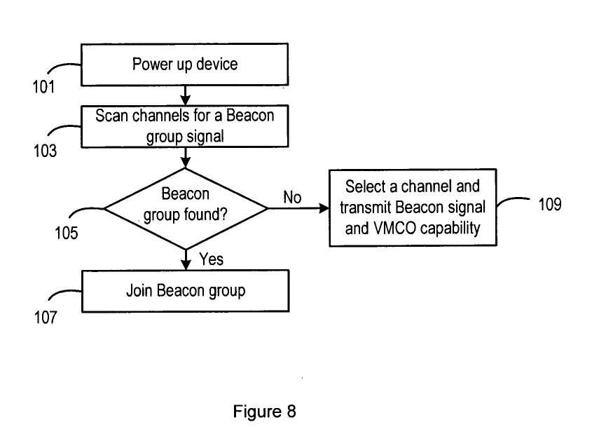

FIG. 8 shows a method of initiating a device in accordance with the invention. In step 101, the device is powered up. In step 103, if the device wishes to use the VMCO scheme, it listens to the available channels for a VMCO Beacon frame in a Beacon Period for one superframe. In one embodiment, the device listens for a VMCO Information Element (IE) in the Beacon Period. In an alternative embodiment, the device listens for a reserved bit in a MAC header field, indicating that a transmitting device is VMCO capable.

If the device does not detect any Beacon frames then the device marks the channel as free or available for use. If the device does detect a Beacon frame on a particular TFC channel and Beacon frame headers are detected with a valid Frame Check Sequence (FCS), then the device is able to receive Beacon signals from other devices using that TFC channel, and the channel is marked as in use. It should be noted that this channel could be in use by conventional devices or VMCO-capable devices. If the device detects a Beacon frame on a particular TFC channel but which has a Beacon frame header with an invalid Frame Check Sequence (FCS), then the device continues to listen on the TFC channel for a further superframe. If a valid FCS is subsequently received, the device operates as described above. However, if a valid FCS is not subsequently received, the device can detect activity in the channel, but cannot obtain further information regarding the channel. Therefore, the device marks the channel as in use.

After one TFC channel is scanned or monitored, the device switches to the next or another TFC channel and repeats the process described above, until all TFC channels have been monitored.

In step 105, the device decides whether a suitable, or any, VMCO Beacon group signal has been found. If so, the device joins the VMCO Beacon group (step 107) in a conventional manner, for example as described in section 17.2 of the ECMA-368 specification. Thus, the device transmits a Beacon signal in an available slot of the next Beacon Period. The device can start communicating with other devices in the network once any collisions in the joining procedure have been resolved.

If no Beacon group, or no suitable Beacon group, is found, the device selects a channel and creates a new Beacon group by transmitting a Beacon frame, which includes some signalling indicating that it is VMCO capable, as described above (step 109). For example, the device can use a reserved bit in a MAC header field, or a bit in an information element (IE). A VMCO Beacon group comprises a number of VMCO devices associated with a common channel (and therefore a common Beacon Period) and a set of associated VMCO channels (i.e. channels that will be unused in the current superframe).

In the diagrams shown below, the channel that is common to the devices, and which contains the VMCO Information Element (in a preferred embodiment), will be referred to below as the “rendezvous channel”, and is labelled TFCᵣ. The associated empty channels are labelled TFCₓ and TFC_{y}. For the purposes of the following description, all devices are assumed to be VMCO-capable devices, and it is assumed that the VMCO Beacon group has been established and is stable.

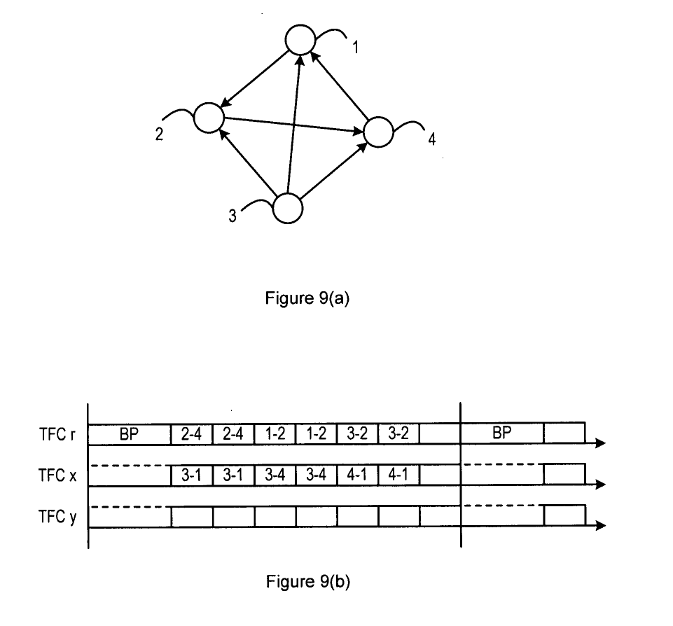

FIGS. 9(a) and (b) show an exemplary scheme for transmission of data between four devices in a network in accordance with the invention. In FIG. 9(a), a network comprising four devices is shown, and, as above, the arrows between the devices indicate the direction that data is to be transmitted between various pairs of devices in the network. Thus, there are six flows of data to be transmitted. It can also be seen that the Beacon group for a device comprises all of the other devices in the network.

FIG. 9(b) shows when the various devices will transmit their data according to the VMCO scheme. Thus, the second device 2 will transmit data to the fourth device 4 in the first two slots of the Data Period on the rendezvous channel, TFCᵣ. At the same time, the third device 3 will transmit data to the first device 1 on the first empty/virtual channel, TFCₓ. In the next two slots of the Data Period, the first device 1 will transmit data to the second device 2 using the rendezvous channel, TFCᵣ, (so the first device 1 will have switched channels between the second and third slots), and the third device will transmit data to the fourth channel using the first empty channel, TFCₓ. In the fifth and sixth slots, the third device 3 will transmit data to the second device 2 using the rendezvous channel, TFCᵣ, and the fourth device 4 transmits data to the first device 1 using the first empty channel, TFCₓ.

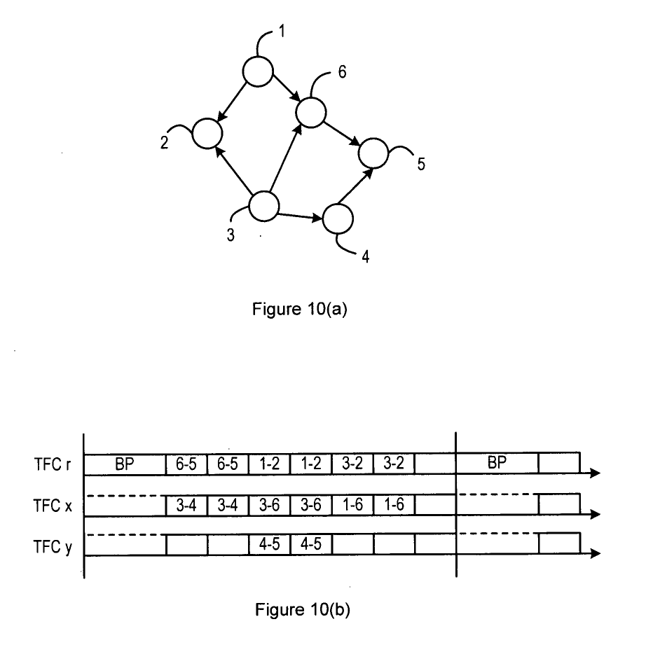

FIGS. 10(a) and (b) show the effect of using the VMCO scheme on a network comprising six devices 1, 2, 3, 4, 5 and 6. In this example, a second empty channel, TFC_{y}, is also used to transmit data. Thus, in the third and fourth slots of the Data Period, three separate transmissions take place on the three different channels, the rendezvous channel TFCᵣ, and two virtual channels TFCₓ and TFC_{y}.

Although this example shows devices in a common Beacon group (i.e. the Beacon group for a device comprises all of the other devices in the network), it will be appreciated that in some embodiments, each device might not necessarily be part of the Beacon group of each of the other devices in the network.

However, it is not just devices that are in a common Beacon group that can use a virtual channel to transmit their data. Referring again to FIGS. 10(a) and (b), assume that device 5 is not in the Beacon group of device 3 (and vice versa), due to the distance between them and/or due to an offset between the start of their respective BPSTs, although both devices are in the Beacon group of device 6. In this case, it is possible for device 3 to transmit its data to device 4 (which is in the Beacon group of device 3) on TFCₓ whilst device 6 transmits its data to device 5 (which is in the Beacon group of device 6) on TFCᵣ. Thus, from the point of view of device 6, device 3 is using a virtual channel to transmit data to a device that is outside of the Beacon group of device 6.

The VMCO scheme described above provides a number of advantages over conventional systems. Devices able to switch channel in the proposed manner have access to slots from more than one channel; yielding an enhanced utilisation of the air interface resource, through an increase in the available bits per second and slots per superframe. This reduces the delay and increases the throughput along with providing the ability to support more active device pairings. Subject to the constraint that devices cannot transmit or receive on two or more different channels at the same time, the potential additional available capacity is of the order of the number “empty” channels.

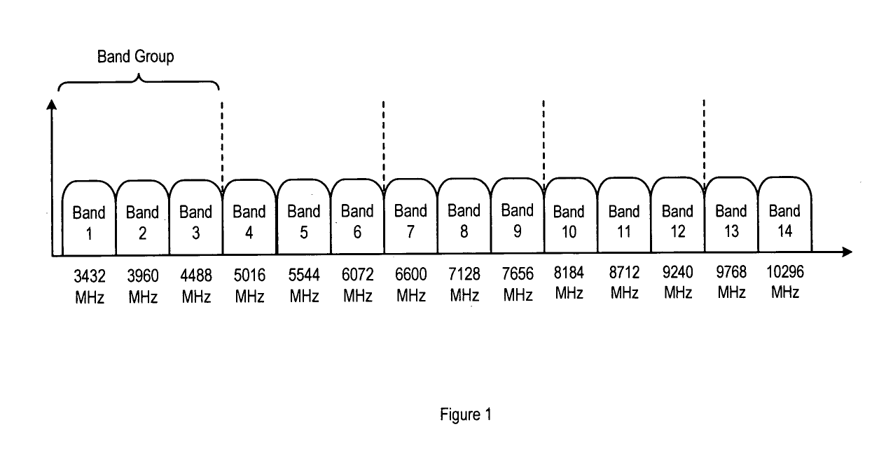

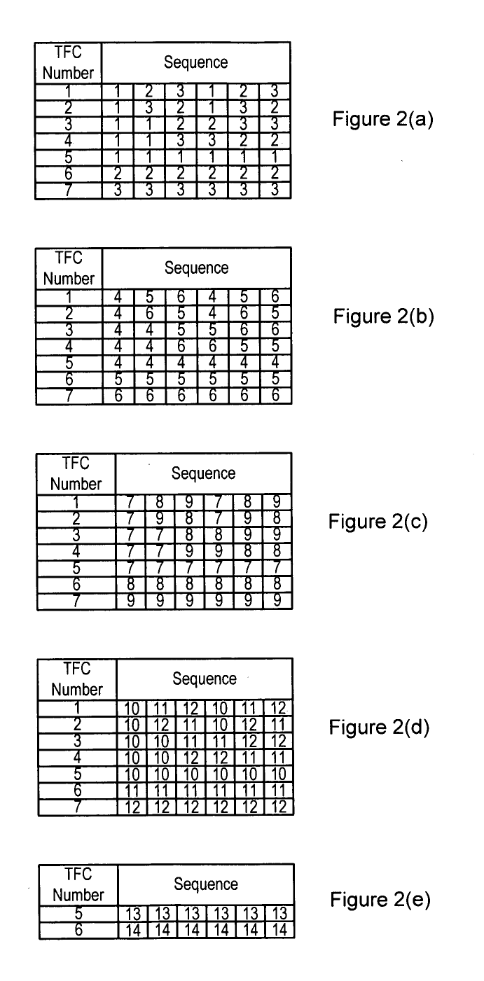

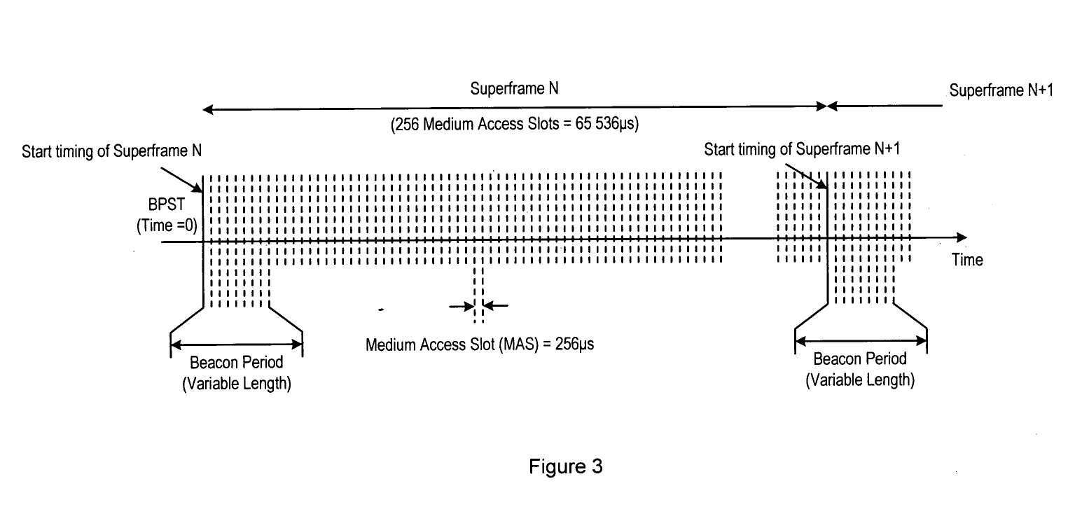

Although the invention has been described with reference to the use of empty/virtual channels within a single band group (as shown in FIG. 1), it will be appreciated by a person skilled in the art that it is possible for devices to identify and use one or more TFC channels from another band group as virtual channels.

The ability to switch channels within a superframe avoids the need to initiate a full channel switch and the resulting disruption that such large scale changes cause. The ability of such “on-the-fly” channel switching can manage dynamic short scale variations in data flows, and more specifically can help manage high throughput burst-mode traffic.

Multiple VMCO groups can co-exist, and they are only limited by the number of available empty channels in the network.

The VMCO scheme only requires devices to have a single radio interface, which keeps implementation costs low.

Finally, the VMCO scheme improves the applicability of ultra wideband networks to dense interconnected environments where individual devices are required to communicate with large numbers of devices, for example where users wish to play a game across several interconnected devices.

In addition to providing the benefits described above, the VMCO scheme in accordance with the invention is fully backward compatible with non-VMCO-capable devices, as these devices ignore (or are unable to detect) the VMCO specific Information Elements in the Beacon Period on the rendezvous channel. However, these devices can join existing Beacon groups according to standard ECMA-368.

It is possible for conventional devices to join or establish Beacon groups on the “empty” channels that would otherwise be used as “virtual” channels by the VMCO group, which means that the non-VMCO-capable devices will simply assert or establish their presence during the Beacon Period on that channel, thus causing collisions for the VMCO devices trying or intending to use that “virtual” channel. Those VMCO devices will then back off and allow the VMCO group to find another channel and/or reassign their slots to another “empty” channel. The presence of conventional devices in the network, or devices not being adapted for the VMCO scheme, means that the system behaviour defaults to that of standard ECMA-368.

The improvement in the usage of the network capacity can be expressed as shown below. Consider an example where fourteen devices combine to form seven simultaneous independent connections (device/node pairs). If a single channel with seven Medium Access Slots is available, and all connections require the same time on the medium, then each connection will be granted one MAS per superframe. However, if six other empty channels are available, then each device pair can each use a separate channel. This means that the data throughput is increased by a factor of 7.

The following calculation considers the available transmission time during a superframe. In all cases, the effective throughput of the medium is generally less than the quoted data rate due to the insertion of inter-frame spacing such as MIFS (minimum inter-frame spacing), AIFS (arbitrary inter-frame spacing), SIFS (short inter-frame spacing) and the Guard Time. By enabling the switching of devices between multiple channels, there is no additional reduction factor that will affect the throughput.

According to the ultra wideband specifications, each superframe lasts 65.536 ms (256 MASs). The available transmission time on one channel is equal to 65.536 * R ms, where R is the reduction factor introduced by the superframe structure of the ECMA 368 standard.

R=(Data Period Length)/(Beacon Period Length+Data Period Length).

In the case where the Beacon Period is occupied by the maximum number of devices (96), R has the minimum value of 87%.

However, because more than one channel is available, the time available for data transmission is a function of the number of available channels participating in the channel switching scheme and the MAS allocation scheme used. However, the maximum total available transmission time on the medium (provided that the optimum channel and data slot allocation policy is possible for the traffic demands between devices) would be:

65.536*R*7 ms per superframe.

The number of channels unavailable for the VMCO operation depends on the number of conventional devices that do not have channel switching per MAS capabilities. If there are no conventional devices, the maximum improvement for the transmission time availability for devices in the same Beacon Group would be:

(65.536*7−65.536)/65.536=600%

If only two channels are available for switching, the maximum improvement reduces to 100%. Regardless it can be seen that sharing even a small number of channels can significantly increase the available capacity.

As described above, the Information Elements are transmitted by the devices in the Beacon Period of the rendezvous channel, and contain resource reservation requests for time slots in the rendezvous channel and for time slots in associated empty channels. These resource reservation requests can be in accordance with the Distributed Resource Protocol (DRP).

The ECMA 368 standard defines two Information Elements relating to DRP reservations; and they are DRP Availability IEs and DRP IEs.

The DRP Availability IE is used to transmit a device's current view of the DRP reservations made within the superframe. The DRP Availability IE comprises a DRP Availability Bitmap that indicates the MASs in the superframe that are being reserved, or have already been reserved by other devices. As only a map for the used section of the superframe needs to be transmitted, the bitmap portion of the DRP Availability IE has a variable length, from 0 to 32 bytes. Thus, when MASs at the end of the superframe are unused, the amount of data in the bitmap is reduced. The DRP Availability Bitmap also comprises the Element ID and a byte which indicates the length of the bitmap.

However, the above IE is not suitable for use with the VMCO technique described above, since channel and time slot reservations need to be made across multiple channels, and the corresponding bitmap size required for the additional empty channels would exceed the available time for transmission of the IE. Therefore, a more compact representation is required.

Therefore, in accordance with an embodiment of the invention, a modified DRP Availability IE is presented, which allows devices to also include the DRP reservations for the empty channels.

The DRP Availability IE must provide devices with a view of the current activity within the empty channels. The availability IE therefore requires a mechanism to transmit the number of available channels (since this can change based on the presence of separate Beacon groups or blacklisting), and the order for transmission of the availability bitmaps of these channels.

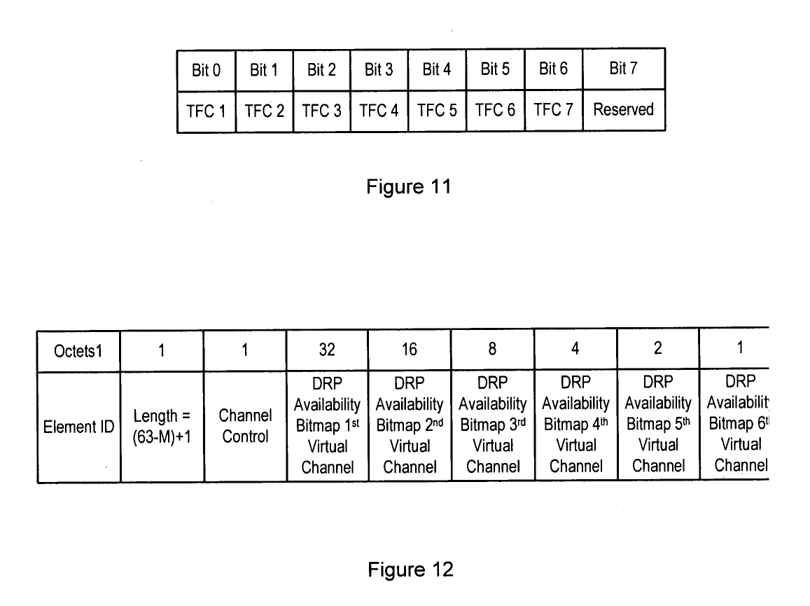

In order to provide this functionality, the availability IE includes an octet as shown in FIG. 11. This octet is referred to as the Channel Control. Bits 0 to 6 indicate whether or TFC channels 1 to 7 respectively are available for use by the VMCO Beacon group, with bit 7 being reserved. If a TFC channel is indicated as unavailable for use (i.e. a 0 in the appropriate position), this will indicate that a bitmap for that channel will not be included in the availability IE. For completeness, the rendezvous TFC channel will be set to 1 indicating that it has data carrying capabilities. However, an additional DRP availability bitmap will not be appended, as a bitmap for this channel is transmitted in a separate IE to maintain backwards compatibility with non-VMCO-capable devices.

Three approaches to providing the availability bitmaps have been identified. These approaches are set out below.

The first approach is based on a reduction of the granularity of the availability bitmap for each successive channel. The format of the availability IE with this approach is shown in FIG. 12. Thus, the availability IE comprises a first octet that indicates the Element ID, followed by an octet that indicates the length of the availability 1E, which varies with the number of empty channels available, followed by the Channel Control. The length is given by (63−M)+1, where M indicates the number of octets to be omitted given that particular channels are unavailable. The length field does not take into account the length of the Element ID and the length field itself.

The availability bitmaps for each virtual channel are then provided. In accordance with this approach, the granularity of each bitmap decreases for each successive virtual channel. Thus, the bitmap for the first virtual channel is represented by 32 octets, the bitmap for the second virtual channel is represented by 16 octets, the bitmap for the third virtual channel is represented by 8 octets, the bitmap for the fourth virtual channel is represented by 4 octets, the bitmap for the fifth virtual channel is represented by 2 octets and the bitmap for the sixth virtual channel is represented by 1 octet. The first, second, third, fourth, fifth and sixth virtual channels can be the TFC channels indicated as available in the Channel Control octet of FIG. 11 taken in any desirable sequence. As mentioned above, the bitmap for the rendezvous channel is provided in a separate IE.

This approach means that it is advantageous for traffic requiring a large number of contiguous time slots to be mapped to channels with lower granularity.

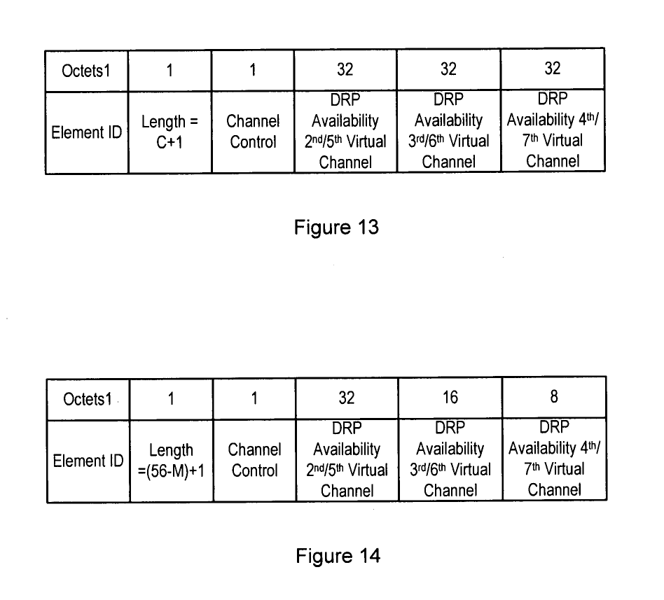

The second approach for providing the availability bitmaps is to reduce the amount of information that needs to be transmitted for the empty/virtual channels. This is done by alternating the empty channels for which availability bitmaps are transmitted within the Beacon Period of a given superframe. Thus, for example, in a first availability IE availability bitmaps for the first, second and third empty channels can be transmitted, while in a second availability IE in the next superframe, availability bitmaps for the fourth, fifth and sixth empty channels can be transmitted. FIG. 13 shows the availability IE in accordance with this approach. It will be appreciated that the empty channels can be divided between the consecutive superframes in any suitable manner, and it is not necessary to divide the channels into the groups shown.

Thus, the availability IE comprises a first octet that indicates the Element ID, followed by an octet that indicates the length of the availability IE, which varies with the number of empty channels available, followed by the Channel Control. The length is given by C+1, where C indicates the number of high bits in the Channel Control field×32. The availability bitmaps for the each of the three selected virtual channels (comprising 32 octets) are then provided.

This approach has the benefit that the full channel availability bitmap can be transmitted for each virtual channel, at the cost of receiving this information for the empty channels every other superframe.

A third approach for providing the empty/virtual channel DRP availability bitmaps is a hybrid combination of the previous two approaches. This approach uses both granular and temporal methods to reduce the required information content. The format of the hybrid availability IE is shown in FIG. 14.

Thus, the availability IE comprises a first octet that indicates the Element ID, followed by an octet that indicates the length of the availability IE, which varies with the number of empty channels available, followed by the Channel Control. The length of the availability IE is given by (56−M)+1, where M indicates the number of octets to be omitted given that particular channels are unavailable. The length field does not take into account the length of the Element ID and the length field itself, since these are always included in the IE.

The availability bitmaps for three of the empty channels are then provided. In accordance with this approach, the granularity of each bitmap decreases for each successive channel. Thus, the bitmap for the second or fifth virtual channels is represented by 32 octets, the bitmap for the third or sixth virtual channels is represented by 16 octets, and the bitmap for the fourth or seventh virtual channel is represented by 8 octets. Again, it will be appreciated that the empty channels can be divided between the consecutive superframes in any suitable manner.

In the following section, an approach for making actual reservations on the empty channels is presented. The availability bitmaps provided as described above are used by devices to obtain information relating to the current state of the MASs within the empty channels. The DRP IE is then used by devices to reserve MASs within these empty channels.

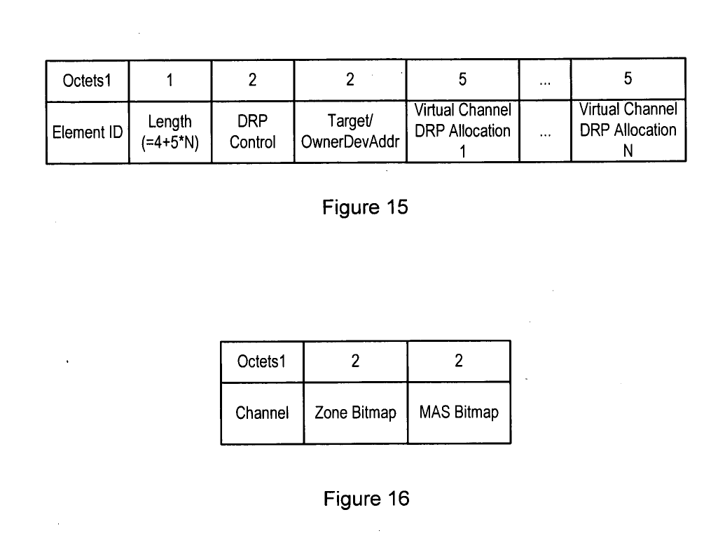

The empty/virtual channel information is included within the new IE by adding an additional octet to the DRP Allocation Field Format that is used to specify the channel a device wishes to make a reservation on. The format of the DRP IE is shown in FIG. 15.

The IE has a format that is identical to the standard DRP IE, with the exception that the DRP allocation field has an added octet that specifies the TFC channel a device wishes to make a reservation on. Thus, the IE comprises a first octet that indicates the Element ID, followed by an octet that indicates the length of the IE, which varies with the number of reservation requests made, followed by two octets representing the DRP Control field (which is defined in section 16.8 of the ECMA-368 specification as giving information relating to the type of reservation, whether the reservation was successful or in conflict with another device), followed by two octets representing the target (i.e. the destination for the data transmission) and device addresses. Then the IE comprises five octets for each empty/virtual channel reservation to be made (Virtual channel DRP allocations 1 to N).

The format of the Virtual channel DRP Allocation field is shown in FIG. 16. Thus, the field comprises an octet indicating the virtual channel on which the time slots are to be reserved, two octets indicating the zone bitmap, and two octets indicating the MAS bitmap.

Within the context of the VMCO scheme described herein, the described IEs with the empty channel DRP allocations provide a mechanism for transmitting a device's current view of the state of the network, and enables devices to make reservations within the network with a minimised IE transmission time (although the time required to transmit the Availability IEs is increased in comparison to standard ECMA-368 operation due to the Availability IEs for the empty channels, the techniques described above minimise the time required to do this). This allows devices requiring both high bandwidth and delay sensitive traffic to make reservations within the empty channels specific to their traffic type. This improves the ability to support more active device pairings and their specific traffic requirements.

While the above Information Elements were developed to meet the specific needs of the VMCO scheme, it will be appreciated that they can be applied to other Beacon-based protocols, either single or multi-channel, where there is a limit on resources available to support or propagate channel reservation information.

Moreover, as described above, an alternative implementation to VMCO specific IEs is an application specific IE.

Therefore there is provided a method and apparatus that allows the use of the available capacity in a communication network to be improved, and which overcomes the disadvantages of conventional schemes.

1. A method of improving the use of the capacity of an ultra wideband network, the network comprising a plurality of channels, the network further comprising a plurality of devices, each device forming a respective beacon group on a first one of the channels, each beacon group including at least one other device in the plurality of devices; the method comprising:
transmitting data from a first device in a beacon group using a channel other than the first channel whilst a second device in the beacon group transmits data using the first channel.

2. A method as claimed in claim 1, wherein the first device is transmitting data to a device that is in the respective beacon groups of the first and second devices.

3. A method as claimed in claim 1, wherein the first device is transmitting data to a device that is not in the beacon group of the second device.

4. A method as claimed in claim 1, wherein the second device is transmitting data to a device that is in the respective beacon groups of the first and second devices.

5. A method as claimed in claim 1, wherein the second device is transmitting data to a device that is not in the beacon group of the first device.

6. A method as claimed in claim 1, wherein the network is further divided into a plurality of contiguous superframes, the method further comprising, at the start of the first superframe, determining a transmission scheme for the devices, the transmission scheme indicating the channel or channels in the plurality of channels that each device is to use to transmit or receive data in the first superframe.

7. A method as claimed in claim 6, wherein the step of determining a transmission scheme comprises each device broadcasting a reservation request indicating one or more time slots in the first superframe and one or more channels in the plurality of channels to be used.

8. A method as claimed in claim 7, wherein each device broadcasts the reservation request during a beacon period at the start of the first superframe.

9. A method as claimed in claim 7, wherein the reservation requests can comprise requests for non-contemporaneous time slots of the first superframe on more than one channel in the plurality of channels.

10. A method as claimed in claim 7, wherein the reservation request is included in an information element.

11. A method as claimed in claim 10, wherein the information element comprises a map indicating the availability of time slots in the first superframe.

12. A method as claimed in claim 11, wherein the map indicates the availability of time slots on the first channel and at least one of the other channels.

13. A method as claimed in claim 12, wherein the number of bits used to represent each channel in the map varies, with the part of the map relating to the first channel being represented by a higher number of bits than the part of the map relating to at least one of the other channels.

14. A method as claimed in claim 11, wherein the map indicates the availability of time slots on the first channel and a subset of the other channels.

15. A method as claimed in claim 12, wherein the map indicates the availability of time slots on the first channel and a subset of the other channels, with the part of the map relating to the first channel being represented by a higher number of bits than the part of the map relating to at least one of the channels in the subset.

16. A device for use in an ultra wideband network, the network comprising a plurality of channels, the device being adapted to form a beacon group with at least one other device on a first one of the channels, the device being further adapted to transmit data to a second device using a channel other than the first channel when the at least one other device in the beacon group is transmitting data using the first channel.

17. A device as claimed in claim 16, wherein the channels are divided into a plurality of contiguous superframes, the device being further adapted to broadcast a reservation request indicating one or more time slots in the first superframe and a channel or channels in the plurality of channels to be used.

18. A device as claimed in claim 17, wherein the device is adapted to broadcast the reservation request during a beacon period at the start of the first superframe.

19. A device as claimed in claim 17, wherein the reservation requests can comprise requests for non-contemporaneous time slots of the first superframe on more than one channel in the plurality of channels.

20. A device as claimed in claim 17, wherein the device is adapted to include the reservation request in an information element.

21. A device as claimed in claim 20, wherein the information element comprises a map indicating the availability of time slots in the first superframe.

22. A device as claimed in claim 21, wherein the map indicates the availability of time slots on the first channel and at least one of the other channels.

23. A device as claimed in claim 22, wherein the number of bits used to represent each channel in the map varies, with the part of the map relating to the first channel being represented by a higher number of bits than the part of the map relating to at least one of the other channels.

24. A device as claimed in claim 21, wherein the map indicates the availability of time slots on the first channel and a subset of the other channels.

25. A device as claimed in claim 22, wherein the map indicates the availability of time slots on the first channel and a subset of the other channels, with the part of the map relating to the first channel being represented by a higher number of bits than the part of the map relating to at least one of the channels in the subset.

26. An ultra wideband network, comprising a plurality of devices, with at least one device being as claimed in claim 16.
